(19) United States
(12) Patent Application Publication
(10) Pub. No.: US 2010/0172232 A1
(43) Pub. Date: Jul. 8, 2010

(54) Noise compensation in data transmission

(76) Inventors: Mario TRAEBER, Pliening (DE); Robert HEILMANN, Muenchen (DE)

Correspondence Address: SpryIP, LLC;IFX, 5009 163rd PL SE, Bellevue, WA, 98006, US

(21) Appl. No.: 12/420,835

(22) Filed: Apr. 9, 2009

Related U.S. Application Data
(60) Provisional application No. 61/142,910, filed on Jan. 7, 2009.

(51) Int. Cl. H04J 3/10; H04B 1/10

(52) U.S. Cl. 370/201; 375/350

(57) ABSTRACT

Embodiments related to noise compensation in data transmission are described and depicted.

### REFERENCE TO RELATED APPLICATIONS

This application claims the benefit of the priority date of U.S. provisional application 61/142,910 filed on Jan. 7, 2009, the content of which are herein incorporated by reference.

### BACKGROUND

Transmission of data in communication systems such as DSL systems, Ethernet systems or other data communication systems is typically influenced by noise. Noise influencing the data transmission can be classified into different noise types. Near-end noise is generated at the near-end of a transmitter. Examples of near-end noise include echo noise and NEXT (Near-end crosstalk) noise. Echo noise originates in a transceiver when a part of the signal transmitted via a transmitter over a link couples into a receive path of the same transceiver thereby disturbing the receiving of data via the receiver of that link. NEXT noise occurs when a plurality of transceivers are arranged at one side of the transmission system and signals transmitted by one of the transceivers couple into the receive paths of another transceiver.

Contrary to the near-end noise, far-end noise is noise which is introduced at the far-end side of a transmitter. FEXT (far-end crosstalk) occurs typically when a plurality of links of the transmission system such as a plurality of wires, cables or lines are assimilated in a same bundle. During the transmission, the signals transmitted on the one link partially couples into other links. Thereby, noise is introduced at the receivers of the far-end side originating from the signals transmitted on the other links.

While for echo, NEXT and FEXT noise the noise source is the transmission of signals in the system itself, in another noise type referred to as alien noise the noise is introduced into the transmission system from outside of the transmission system.

While alien noise is hard to address, echo, NEXT and FEXT noise can be compensated by using adaptive filters. In order to compensate the noise, a replica of the respective transmit signals are provided from a respective transmit path to an adaptive filter. By properly setting the filter coefficients of the adaptive filter, a replica of the noise is generated at the output of the adaptive filter. Noise-compensated receive signals are then generated by subtracting the noise replica from the received signals.

### BRIEF DESCRIPTION OF THE SEVERAL VIEWS OF THE DRAWINGS

FIG. 1 shows a block diagram according to an embodiment;

FIG. 2 shows a further block diagram according to an embodiment;

FIG. 3 shows a further schematic diagram according to an embodiment;

FIG. 4 shows a further block diagram according to an embodiment;

FIG. 5 shows a flow diagram according to an embodiment;

FIGS. 6a and 6b show further diagrams according to an embodiment; and

FIG. 7 shows a further block diagram according to an embodiment.

### DETAILED DESCRIPTION

The following detailed description explains exemplary embodiments of the present invention. The description is not to be taken in a limiting sense, but is made only for the purpose of illustrating the general principles of embodiments of the invention while the scope of protection is only determined by the appended claims.

In the exemplary embodiments shown in the drawings and described below, any direct connection or coupling between functional blocks, devices, components or other physical or functional units shown in the drawings or described herein can also be implemented by an indirect connection or coupling. Functional blocks may be implemented in hardware, firmware, software, or a combination thereof.

Further, it is to be understood that the features of the various exemplary embodiments described herein may be combined with each other, unless specifically noted otherwise.

In the various figures, identical or similar entities, modules, devices etc. may have assigned the same reference number.

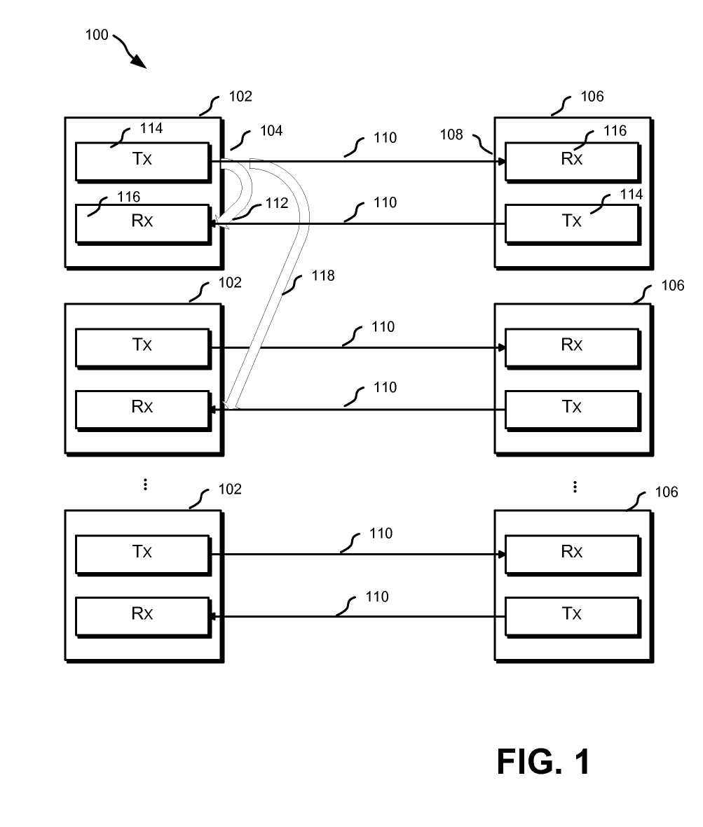

Referring now to FIG. 1, an embodiment of a data transmission system 100 is shown. The data transmission system 100 includes a first plurality of transceivers 102 arranged at a first side 104 of the data transmission system 102 and a second plurality of transceivers 106 arranged at a second side 108 of the data transmission system comprised of 102 and 106. Each of the transceivers 102 is coupled via one of a plurality of transmission links 110 to a respective one of the transceivers 106. Transmission links 110 may include twisted pair wires, Ethernet lines etc. The data transmission system may be in one embodiment a DSL system such as a SDSL (symmetrical DSL), SHDSL (single-pair high speed DSL), ADSL (asymmetric DSL) or VDSL (very high speed DSL) system.

FIG. 1 shows for a connection of two transceivers separate links in upstream and downstream direction. It is to be understood that such two links may be implemented by a single transmission line or pair of wire. For example, the data communication system may be a frequency division multiplex access system or frequency overlapping access system allowing transferring data over a same line or pair of wire in both directions within different frequency bands. For implementing two links by a same line or pair of wire, 2-to-4 wire converters, hybrids or other devices may be used to split the signals on the line to the respective receive path and transmit path. The data communication system may use a single carrier modulation technique such as used for example in SDSL and SHDSL or may use a multi-carrier modulation technique such as for example DMT (discrete multi tone) used for example in ADSL and VDSL. However, it is to be noted that the described embodiments is not limited to these exemplary data communication system and may be used for any other appropriate communication system.

Further referring to FIG. 1, near-end noise is introduced into the data communication system. The near-end noise includes echo noise which is exemplary shown for one transceiver in FIG. 1 with reference number 112. As explained above, echo is introduced when signals transmitted via a respective transmit path 114 of a transceiver 112 couple into a receive path 116 of the same transceiver. Furthermore, the near-end noise includes NEXT noise which is exemplary shown in FIG. 1 between two transceivers with reference number 118. NEXT noise is introduced when signals transmitted via a respective transmit path 114 of one of the transceivers 112 couple partially into a receive path of another one of the transceivers 112. While FIG. 1 shows only exemplary one echo noise and one NEXT noise coupling, it is to be understood that in a transmission systems with multiple transceivers echo noise may occur in each of the transceivers and NEXT noise may be introduced from each transmit path of all transceivers into a respective receive path of all transceivers.

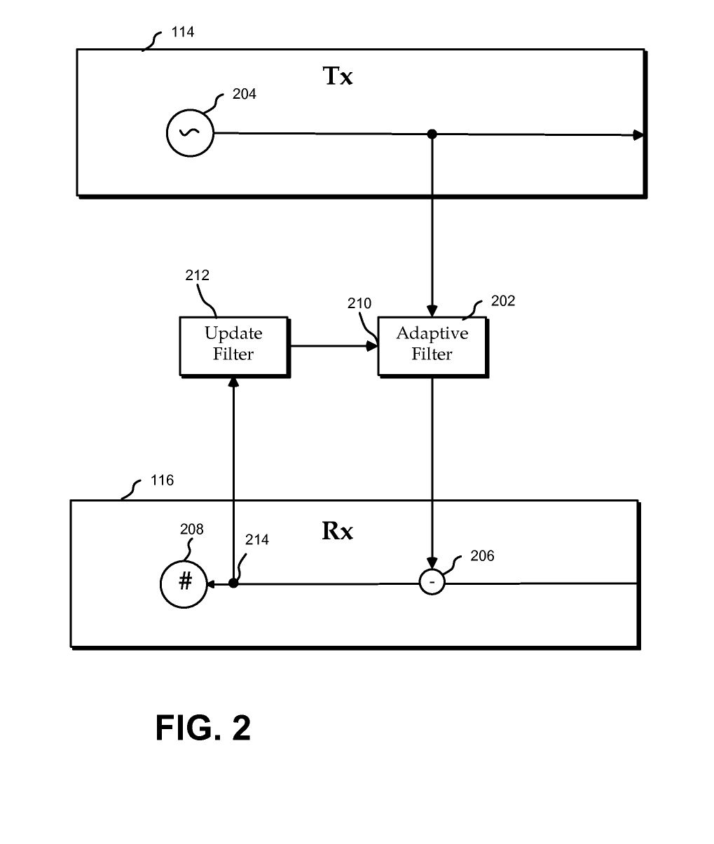

In order to compensate the near-end noise, i.e. echo or NEXT noise, an adaptive filter 202 is provided as shown in FIG. 2. While FIG. 2 shows only one adaptive filter, it is to be understood that the system may have multiple adaptive filters to cancel each corresponding near-end noise. Depending on the near-end noise to be compensated, the adaptive filter 202 may also be referenced as an echo canceller or NEXT canceller. The adaptive filter 202 used for near-end noise compensation has an input which is coupled to the respective transmit path 114 from which the near-end noise originates and an output which is coupled to the respective receive path 116 in which the influence of the noise will be compensated (canceled) Depending whether the near-end noise to be compensated is echo or NEXT, the transmit path 114 and the receive path 116 are provided in a same transceiver or in separate transceivers. Transmit path 114 drains a transmit data signal from a signal source 206 and transmits this signal over the respective link coupled to the transmit path. The adaptive filter 200 receives at the input a duplicate of the signal transmitted via the transmit path 114. The duplicate is then provided to an input of the adaptive filter. By properly setting the adaptive filter coefficients, a signal is then generated at the output of the adaptive filter which is an estimate of the actual near-end noise introduced into the receive path 116. Therefore by subtracting this estimate at a node 206 from the signal received at the receive path 116, a compensated signal is generated which is essentially free of the near-end noise component introduced by the respective transmit path 114 provided that the filter coefficients are properly determined and set. The compensated signal is then provided to a data sink 208 for further processing.

To determine and set the filter coefficient of the adaptive filter 204, a training of the filter coefficients of the adaptive filter 202 prior to activating the link is performed. The training of the adaptive filter prior to the learning of the parameters of the link may also be referred herein as prelearning or simply as filter learning. In the prelearning the adaptive filter compensating the near-end noise is therefore trained prior to determining or training the link itself, i.e. prior to determining the parameters for communicating data over this link such as a SNR determination, equalizer training etc. In the prelearning, the filter is therefore trained right from the start, i.e. from a previously untrained state where the starting of a session for that link has just been indicated and no previously training of the filter has been performed for this session. The previously untrained adaptive filter is then trained such that no significant residual near-end noise remains after the compensation node 206 after the training (learning) of the near-end noise compensation filters. Subsequent to this prelearning of the compensation filters the learning of the link is performed in a virtually near-end noise free environment.

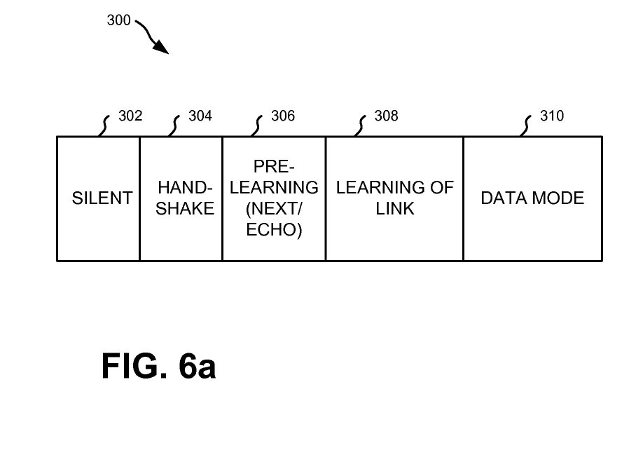

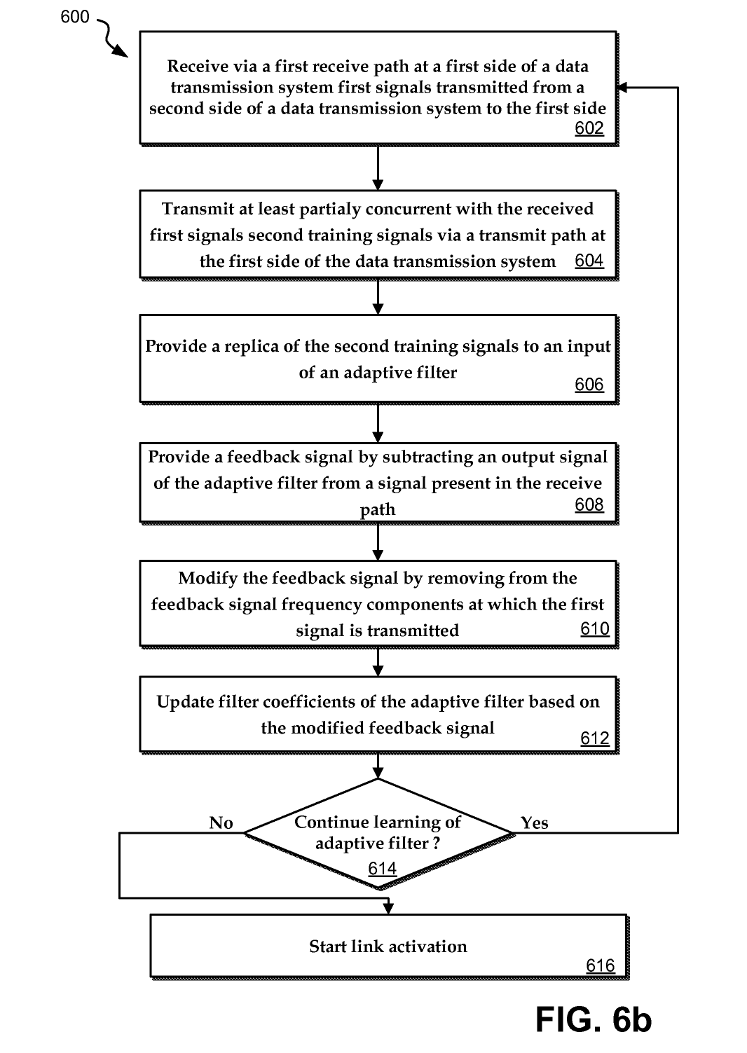

FIG. 6a shows an operation sequence 300 according to an embodiment for illustrating the above. The operation sequence starts with a silent phase 302 in which no signals are transmitted on the link. The silent phase may for example be obtained when a transceiver is not connected to the link or when a transceiver or a modem containing the transceiver is not powered. In embodiments, a link may also be forced to enter a silent phase when a restart is performed. After the silent phase 302, a handshake phase 304 occurs. In the handshake phase 304 both transceivers send handshake signals. The handshake signals in the handshake phase 304 may include handshake signals according to the ITU G.hn standard but are not limited to this specific type of handshake signals. After the handshake phase 304, the above described prelearning phase 306 is entered in which the NEXT and/or echo compensation is trained. It is to be noted that in one embodiment the prelearning may be performed during the handshake phase 304, i.e. the handshake signals of handshake phase 304 are transmitted simultaneously with the training of the NEXT and/or echo compensation. After successfully completing the prelearning phase 306, the learning of the link is performed in phase 308. Having the learning of the link completed, the systems are ready to enter the data mode phase 310 in which the transmission of (user) data between the two modems starts. The data transmission phase 310 is sometimes also referred to as showtime. For updating the coefficients of the adaptive filter during training in the prelearning phase, several techniques may be used. In one embodiment, the training may include a LMS (least mean square) algorithm which will be described later in more detail.

In the following, several embodiments will be described which provide a successful training of the adaptive filter in the prelearning phase prior to the link activation when the transceiver (link partner) or a plurality of transceivers at the other side (remote side) of the transmission system is not silent, i.e. signals are transmitted to the side of the trans-mission system performing the training. As will be described below in more detail, the signals transmitted from the other side during the filter training may in one embodiment include handshake signals. In one embodiment, the signal transmitted during the training may be signals limited to a predetermined frequency band. In other embodiments, the signals may be BPSK (Binary Phase Shift Keying) modulated signals. However, this list of signal types should not be understood as a limitation of the invention. Since the embodiments described herein do not setup any communication channel to the remote side it is possible that the link partner may or may not send any of the mentioned signals at any time with any duration. In other words, the embodiments described herein allow to use the concept of training echo and/or NEXT during a transmission of signals from the remote side but the transceivers are also capable without any change or reconfiguration to train echo and/or NEXT compensation when the link is silent during the prelearning phase, i.e. when the transceiver at the remote side is programmed or configured to be silent during the prelearning phase. The embodiments described herein therefore provide a great flexibility in that no reconfiguration, exchange of components or switching is necessary to provide training for different type of modems connected to the link, i.e. to train transceivers which transmit signals such as handshake signals during the prelearning and transceivers which do not transmit signals during the prelearning.

Generally any type of band-limited signals transmitted during the prelearning by the remote side is suitable for proper operation. This includes most of the signals which are used for startup indications and configuration exchange in modern communication systems. An example is the ITU-G.handshake (G.hs) signal for DSL systems.

The training of the adaptive filter in the presence of signals transmitted from the remote side to the side performing the filter training is achieved according to embodiments by utilizing a feedback path for updating the adaptive filter and eliminating a part of the feedback signal before the update signal is utilized in the adaptive filter. In other words, a part of an error signal determined during the training is eliminated before updating the adaptive filter based on the determined error signal. According to one embodiment shown in FIG. 2, an update filter 212 (update error filter) is provided in the feedback path between the node 206 and the update input 210 of the adaptive filter. During the prelearning, training signals are transmitted by the respective transmit path 104. In general, training signals are all signals which allow training of NEXT and/or echo compensation. The training signals may include for example wide-band random signals. Such signals may provide statistically independent signals over the whole or at least a significant range of the frequency spectrum used for data transmission which allows a fast learning of the filter coefficients. The training signal may be transmitted continuously or may be transmitted with silent periods in between.

The training signals provide a near-end noise for the receive path 106. During the training, the task is to determine the amount of this noise and to successively update the filter coefficients in order to approach filter coefficients which provide at least acceptable near-end noise compensation. In the receive path, the signals downstream of the node 206 represent the compensated signals which have been subtracted by the output of the adaptive filter. The signal downstream of node 206 for example the signal at node 214 would represent the momentary error of the cancellation (compensation) provided by the adaptive filter when no signals are received at the receive path 106 from the other side (remote side). However, in the presence of signals from the remote side received by the receive path 106, this is no longer true. In other words, the signals received from the remote side provide a noise source for the error signal to be determined during the filter learning. This noise source can in practice dominate the receive signal power such that conventional filter training implementations do not converge to satisfactory filter coefficients.

The update filter 212 however removes this noise source prior to utilizing the feedback signal for updating the filter during filter learning. Therefore, even during the receiving of the signals from the remote side, learning of the filter coefficients is possible. The filter 212 may in one embodiment be a simple notch filter. However, any other filter tailored to the type of remote signal may suit as well. For very low frequency signals a high-pass filter may be used in one embodiment.

It is to be noted that by utilizing the update filter for filtering the error signal, the error signal fed back to the adaptive filter does no longer include the disturbing signals received from the link partner. However, not only the received signal from the remote side is eliminated by the update filter at all notch frequencies of the update filter 212 but also all components of the error signal which is required for training the coefficients are filtered out at the notch frequencies of the filter. In other words, the adjustment of the adaptive filter parameters is not influenced by the near-end noise at the frequencies eliminated by the update filter 212.

Therefore, the filter coefficients determined by utilizing the update filter may differ from filter parameters when using existing filter training with a silent link partner since the learning of the adaptive filter 202 will be provided without any information of the near-end noise at the notch frequencies. However, when using certain signals, the elimination of these signals at their respective transmit frequencies by the update filter provides only a small or negligible effect on the learned filter coefficients. Such signals include but are not limited to signals which have a small frequency bandwidth compared to the overall frequency bandwidth of the transmission system and/or signals which are located at low frequencies. Since the near-end noise follows a high-pass characteristic, the influence to the near-end noise gets stronger at higher frequencies. Or in other words the near-end noise is small or negligible at such low frequencies. Therefore, according to embodiments, signals transmitted during the training which have one or both of the above described criteria causes an influence of the filtering by the update filter which is small or negligible.

For example, handshake signals according to G.handshake (G.hs ITU G.994.1) are transmitted within a narrow frequency band at only low carrier frequencies. By setting the update filter 212 such that the G.handshake signals are eliminated, the influence of the elimination for the error update is rather small. For example, for SHDSL systems the carrier frequencies of the G.handshake are located at 12 kHz and 20 kHz and BPSK modulation is used for transmitting the signals. Broadband systems such as DSL-systems typically employ a bandwidth of 500 kHz and more. Therefore, the bandwidth of the G.handshake signals is less than 8% of the total bandwidth. Thus, according to one embodiment, the signals which are transmitted from the link partner at the remote side to the link partner training for near-end noise compensation are G.handshake signals. Since handshake signals are required to be transmitted by some technical standards, the above described embodiment allows providing a near-end noise training in compliance with these technical standards. It is to be understood that the above are only examples of signals which can be transmitted by the link partner during the near-end noise training.

In general, during the prelearning at the near-end side, the other side of the transmission system, i.e. the link partner, has no knowledge of the prelearning. Therefore, the link partner will generally continue transmitting signals to the other side. As outlined above, the embodiments described can address such situations in that it provides a concept for prelearning in the presence of a continuously transmitting link partner.

In embodiments, the update filter 212 is placed in the update feedback path of node 214. This avoids a notch in the receive signal which would impact data-transmission negatively. Placing the update filter upstream of node 206 would change the near-end noise transfer function and would not allow a proper operation since the filter has to be bypassed after prelearning. Bypassing the filter at the position upstream of node 206 after learning would then cause a phase change for signals provided to node 206. Since the phase of the signals provided during the prelearning to node 206 is different than the phase after the prelearning, the learning would be false and a proper operation after the prelearning would not be possible. Having the update filter 212 placed in the update feedback path of node 214 allows to remove (bypass) this filter when switching from prelearning into modem training or datamode which is not the case in other arrangements for the adaptive filter.

The update filter 212 is in one embodiment a band stop filter. In one embodiment wherein handshake signals are transmitted by the remote side, a notch of the band stop filter is set to the handshake carrier frequency of the respective link partner. In other embodiments, the update filter 212 may be a filter with a high-pass characteristic. Such filters may be useful for example when a high bandwidth has to be filtered out by update filter 212.

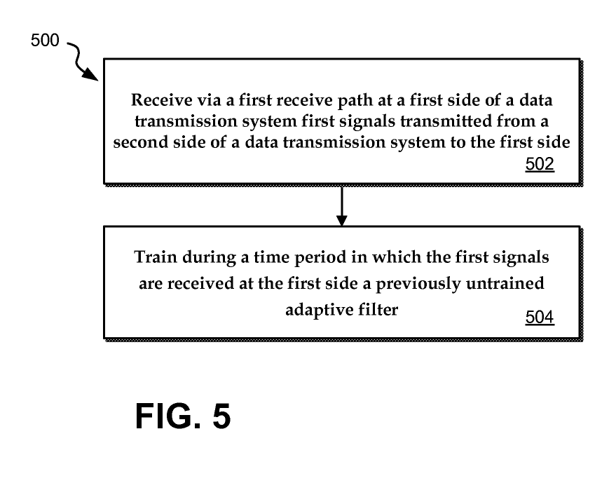

A diagram 500 illustrating an embodiment for learning of the adaptive filter shown in FIG. 2 in the prelearning phase is described now with respect to FIG. 5. At 502, a first signal (which may be a handshake or other signal) is received at a first side of a data transmission system from a second side of the data transmission system. In other words, at 502 the remote transceiver transmits the first signal to its link partner at the first side of the transmission system.

At 504, the previously untrained adaptive filter is trained during the receiving of the first signals at the first side. In embodiments, for training the adaptive filters training signals are transmitted by the transmit path 114 and the training signals are at least partially transmitted concurrent with the receiving of the first signals by the receive path. Although 502 and 504 are show in separate blocks, it is to be understood that the operation described in 502 and 504 may be simultaneously and therefore may be provided also in a single block. Since the first signal provide a noise source distorting the training, the first signals may also be referenced in the following as distorting signals.

A flow diagram 600 explaining in more detail a procedure for learning of the adaptive filter in the prelearning phase according to a further embodiment is shown in FIG. 6b. At 602, the distorting signal is received at the first side of the data transmission system from the second side of the data transmission system. At 604, second signals are transmitted via a transmit path of the first side of the data transmission system at least partially concurrent with the received first signals. The second signals constitute the training signals which are capable to provide echo/NEXT compensation training and which may for example include wide-band random signals as outlined above. In the following, these second signals may also be referred to as training signals. At 606, a replica of the training signals is provided to an input of an adaptive filter. At 608, a feedback signal is provided by subtracting an output signal of the adaptive filter from a signal present in the receive path. At 610, the feedback signal is modified by removing from the feedback signal frequency components at which the first signal is transmitted. At 612 the filter coefficients of the adaptive filter are updated based on the modified feedback signal. At 614 it is determined whether the filter learning is to be continued or not. In case it is determined that the filter learning is to be continued, the procedure again moves to 602 and the process is repeated. If it is determined at 614 that the filter learning is finished and no longer continued, the prelearning phase is completed and the procedure moves to 616 in which the link is activated to start the link training as described with respect to FIG. 6a. As outlined above, in some embodiments handshake signals may be exchanged between 614 and 616.

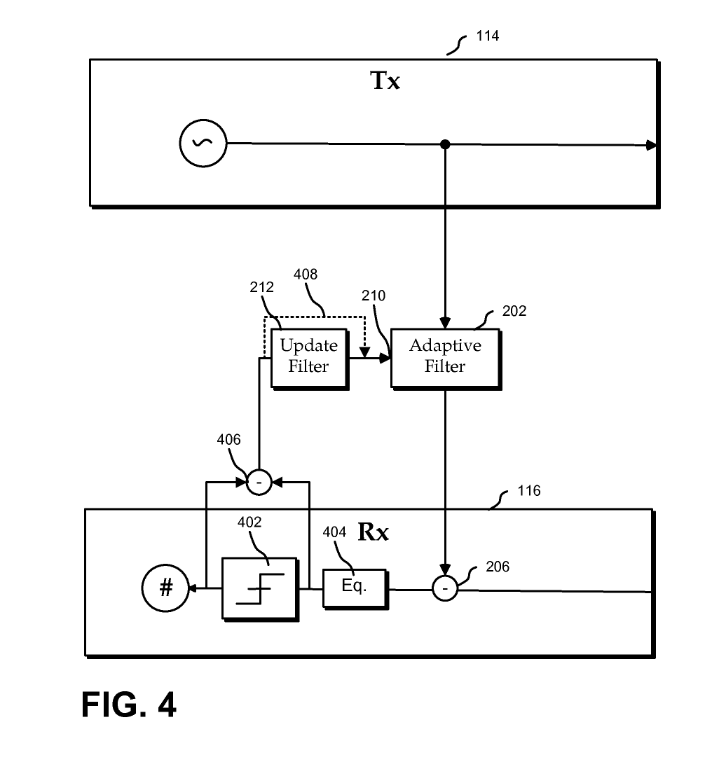

For updating the filter coefficient an update algorithm is provided which may be for example a LMS (least mean square) algorithm. In the embodiment shown in FIG. 2, the feedback signal is an error-based signal, i.e. the signal provided to the update input of the adaptive filter is a measure of the error caused by the near-end noise. Once the transceivers at both sides are linked up, the update-algorithm may change from an error based updating to a decision directed updating. Decision directed updating feeds back to the adaptive filter the sign of a slicer error rather than the error itself. A slicer error is an error which is made by a slicer when demodulating the received data signal. When switching from the error based updating to the decision based updating, the adaptive filter may also be bypassed. FIG. 4 shows a bypass path 408 which is provided parallel to the adaptive filter. By providing respective control signals, the bypassing of the adaptive filter may be initiated for example when the prelearning phase has been completed. In addition thereto, the bypassing path may also be used when it is possible to determine that the remote transceiver is configured to be silent during the prelearning. However, in many cases this determination may not be possible since in principle the type of operation at the other remote side is unknown for a transceiver. Nevertheless, as outlined above, by having the adaptive filter during the prelearning phase switched in the feedback path, it is possible to train the adaptive filter independent whether the remote side is transmitting signals or is silent during the prelearning. While the bypass path is shown in connection with FIG. 4, it is to be noted that the bypass path may as well be provided in any other embodiment described herein. FIG. 4 further shows a slicer 402 placed after an equalizer 404. A duplicate of the signal prior to the slicer is feed to a first input of a subtraction node 406. A duplicate of the output signal of the slicer is feed to a second input of the subtraction node 406. The subtraction of the signal prior to the slicer and the output signal of the slicer results in a signal representing the slicer error. In embodiments, in order to allow switching to a decision-based operation, a further block may be switched into the feedback path after the subtraction node 406 in order to determine the sign of the error. This sign-error signal may then be provided to the update filter 212, or when the update filter 212 is bypassed, directly to the adaptive filter.

In the embodiment having the update filter arranged in the feedback loop between node 206 and update input 210, the switching from an error-based update to a decision-based update can be achieved at any time, e.g. after successful modem training, without providing a distortion to the operation such as an interrupting of the filter operation or a changing of the CTC impulse response. An embodiment having the update filter upstream of the node 206 provides distortion to the operation and requires some additional measures to address these distortions.

LMS techniques which may be used in embodiments for updating the filter coefficients will now be described in the following. A LMS algorithm according one embodiment may use the following algorithm:

c(n+1)=c(n)+μ·e(n)·x(n).

In the above algorithm, c(n) may represent the coefficient presently used, c(n+1) may represent the calculated new coefficient, e(n) may represent the slicer error, x(n) may represent the filter input and μ may represent a weighting factor. In one embodiment, e(n) may represent a sign of the slicer error rather than the value of the slicer error. In one embodiment, x(n) may represent the sign of the filter input. In a further embodiment e(n) may represent the sign of the slicer error and x(n) may represent the sign of the filter input. In one embodiment, the weighting factor μ may be a variable which may be adjusted during the filter training.

The described concept of training near-end noise may be provided when a single link of a plurality of link is to be activated from a previous deactivated state. Other embodiments include a situation when a plurality of links is going to be activated such as for example when the whole transmission system is starting from a previous idle state.

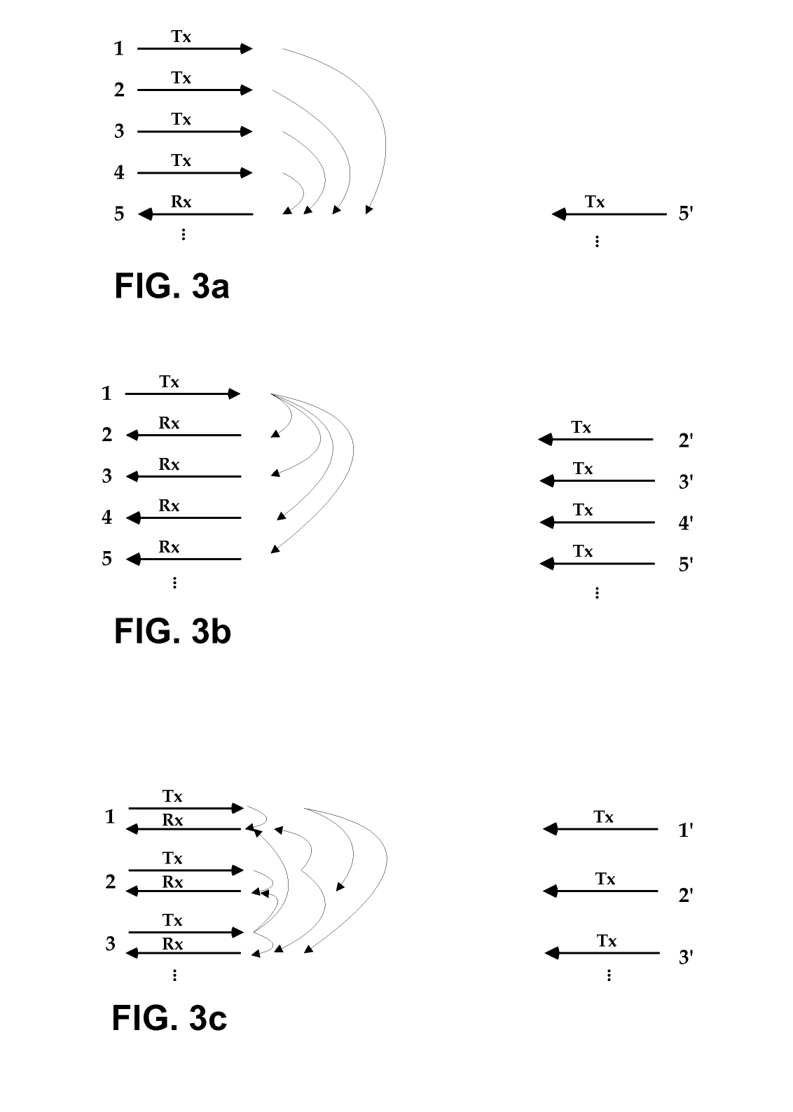

The above described concept can be implemented such that multiple adaptive filters are trained in parallel. FIGS. 3a-3c show several embodiments in which multiple adaptive filters for NEXT noise cancellation are trained in parallel.

FIG. 3a shows an embodiment of a prelearning for multiple adaptive filters in parallel. In this embodiment the multiple adaptive filters for cancelling NEXT noise introduced by the transmit paths of multiple transceivers (disturbers) into one receive path (victim) of a transceiver (transceiver 5) are trained in parallel. In FIG. 3a the transmit paths of transceivers 1,2,3,4 are shown to be transmitting the training signals in parallel. Adaptive filters which are respectively coupled between the transmit paths transmitting the training signals and the victim receive path (receive path of transceiver 5 in FIG. 3a) are trained in parallel while the victim receive path receives signals such as for example activation request signals from its link partner, i.e. from the transmit path of the transceiver 5′ at the far-end side of the transmission system.

FIG. 3b shows a further embodiment of a prelearning for multiple adaptive filters in parallel. In this embodiment, only one disturber, i.e. the transmit path of transceiver 1 transmits training signals. The adaptive filters which are respectively coupled between this disturber transmit path and the respective victim receive paths of the other near-end transceivers (in FIG. 3b transceivers 2-5) are trained in parallel. During this training, each of the victim receive paths receives signals such as for example activation request signals from the respective link partner, i.e. from the transmit paths of transceivers 2′-5′ at the far end side.

FIG. 3c shows a further embodiment wherein each of the multiple transceivers transmits training signals. In this embodiment, the NEXT cancellation filters between each receive path and each transmit paths of the multiple transceivers are trained in parallel. For simplicity, FIG. 3c shows only 3 transceivers and the respective NEXT couplings between these 3 transceivers. As shown in FIG. 3c, each of the victim transmit paths receives signals such as for example activation request signals from the far-end transceivers, i.e. transceivers 1′-3′.

As shown in FIG. 3c, in addition to the NEXT noise training, the echo noise training can be performed parallel to the NEXT noise training. Hence, also each echo cancellation filter is trained parallel to the training of the NEXT cancellation filters.

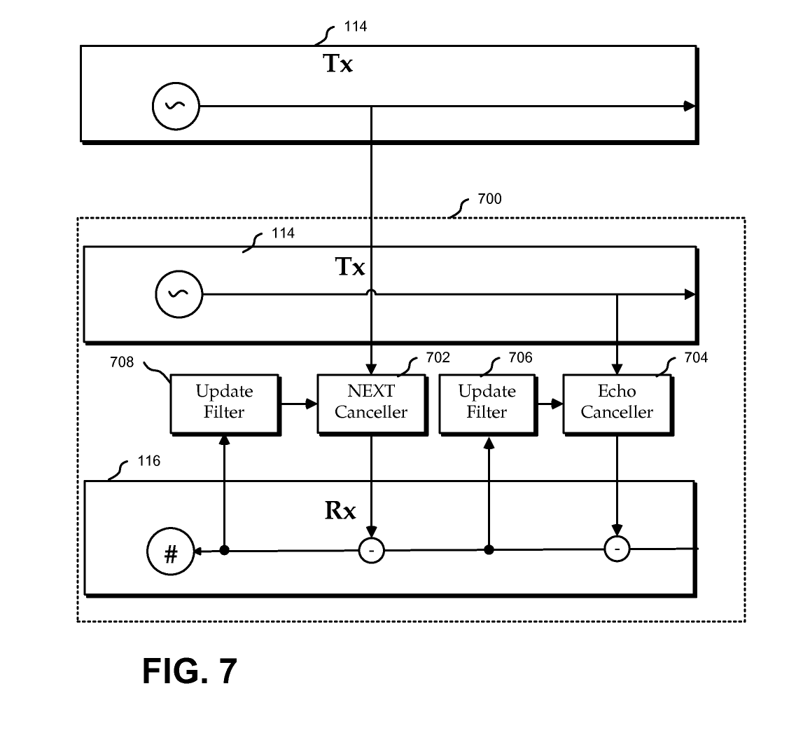

An embodiment for implementing a parallel training of echo noise and NEXT noise in the presence of a received signal in the victim receive path is shown in FIG. 7. FIG. 7 shows a transceiver 700 having a transmit path 114 and a receive path 116 and a further transmit path of a further transceiver. A first adaptive filter 702 implemented as NEXT canceller is coupled to the further transmit path. A second adaptive filter 704 implemented as an echo canceller is coupled to the transmit path 114 of the transceiver 700. As shown in FIG. 7, for each of the adaptive filters 702 and 704 a respective update filter 708 and 706 is provided in the respective feedback path.

In the above description, embodiments have been shown and described herein enabling those skilled in the art in sufficient detail to practice the teachings disclosed herein. Other embodiments may be utilized and derived there from, such that structural and logical substitutions and changes may be made without departing from the scope of this disclosure.

This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

It is further to be noted that specific terms used in the description and claims may be interpreted in a very broad sense. For example, the terms “circuit” or “circuitry” used herein are to be interpreted in a sense not only including hardware but also software, firmware or any combinations thereof. The term “data” may be interpreted to include any form of representation such as an analog signal representation, a digital signal representation, a modulation onto carrier signals etc. The term “information” may in addition to any form of digital information also include other forms of representing information. The term “entity” may in embodiments include any device, apparatus circuits, hardware, software, firmware, chips or other semiconductors as well as logical units or physical implementations of protocol layers etc. Furthermore the terms “coupled” or “connected” may be interpreted in a broad sense not only covering direct but also indirect coupling.

It is further to be noted that embodiments described in combination with specific entities may in addition to an implementation in these entity also include one or more implementations in one or more sub-entities or sub-divisions of said described entity. For example, specific embodiments described herein described herein to be implemented in a transmitter, receiver or transceiver may be implemented in sub-entities such as a chip or a circuit provided in such an entity.

The accompanying drawings that form a part hereof show by way of illustration, and not of limitation, specific embodiments in which the subject matter may be practiced.

In the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, where each claim may stand on its own as a separate embodiment. While each claim may stand on its own as a separate embodiment, it is to be noted that—although a dependent claim may refer in the claims to a specific combination with one or more other claims—other embodiments may also include a combination of the dependent claim with the subject matter of each other dependent claim.

It is further to be noted that methods disclosed in the specification or in the claims may be implemented by a device having means for performing each of the respective steps of these methods.

What is claimed is:

1. A method comprising:
receiving via a first receive path at a first side of a data transmission system first signals transmitted from a second side of a data transmission system to the first side; and
training during a time period in which the first signals are received at the first side a previously untrained adaptive filter, the adaptive filter being arranged at the first side of the data transmission system to compensate near-end noise for the first receive path.

2. The method according to claim 1, further comprising:
transmitting during the training second signals from the first side to the second side of the data transmission system; and
training the adaptive filter based on noise induced by the second signals in the first receive path at the first side of the data transmission system.

3. The method according to claim 2, wherein the adaptive filter is configured for compensation of echo noise.

4. The method according to claim 2, wherein the adaptive filter is configured for compensation of NEXT noise, wherein the first signals are received via the first receive path from a first link of a plurality of links of the data transmission system and wherein the second signals are transmitted via a first transmit path over a second link of the plurality of links of the data transmission system.

5. The method according to claim 4, further comprising:
training parallel to the adaptive filter at least a second adaptive filter arranged at the first side of the transmission system to compensate NEXT noise induced from the first transmit path into a second receive path, wherein the second receive path receives during the parallel training third signals transmitted from the second side of the transmission system over a third link to the second receive path, the second adaptive filter being trained based on noise induced by the second signals into the second receive path at the first side of the data transmission system.

6. The method according to claim 4, further comprising:
training parallel to the adaptive filter at least a second adaptive filter the second adaptive filter being arranged at the first side of the transmission system to compensate NEXT noise induced from a second transmit path into the first receive path, the second transmit path transmitting during the parallel training third signals from the first side over a third link to the second side, the second adaptive filter being trained based on noise induced by the third signals into the first receive path.

7. The method according to claim 1, further comprising:
transmitting via a first plurality of transmit paths during a training period on each of a plurality of links first signals from the first side to the second side;
transmitting during the training period on each of the plurality of links second signals from the second side to a first plurality of receive paths at the first side; and
training in parallel a plurality of adaptive filters, the plurality of adaptive filters including the first adaptive filter, each of the plurality of adaptive filters being arranged at the first side to compensate near-end noise induced from one of the first plurality of transmit paths to one of the first plurality of receive paths.

8. The method according to claim 7, wherein the plurality of adaptive filters includes a plurality of echo filters and a plurality of NEXT compensation filters, the method further comprising:
training in parallel the plurality of echo filters and the plurality of NEXT compensation filters.

9. The method according to claim 1, wherein the adaptive filter is trained during a start-up of the data transmission system or during a joining of a new link.

10. The method according to claim 1, further comprising:
updating filter coefficients of the adaptive filter during the training by utilizing an update signal derived from the first receive path, wherein frequency components of the update signal are removed prior to utilizing the update signal for updating the adaptive filter.

11. The method according to claim 1, wherein the training of the adaptive filter is performed prior to a link activation.

12. The method according to claim 1, wherein the received first signals are handshake signals.

13. The method according to claim 1, wherein the received first signals are BPSK modulated signals with an transmit power being concentrated in a bandwidth small compared to an overall transmission bandwidth of the data transmission system.

14. A device comprising:
a receive path to receive at a first side of a data transmission system first signals transmitted from a second side of a data transmission system to the first side;
an adaptive filter being arranged at the first side of the data transmission system and configured to compensate near-end noise for the first receive path; and
a training circuit to train the adaptive filter, wherein the training circuit is configured to train the previously untrained adaptive filter during a time period in which the first signals are received.

15. A device comprising:
a receive path;
an adaptive filter to provide near-end noise compensation for the receive path;
a circuit configured to train the adaptive filter utilizing a feed-back signal derived from the receive path, wherein the circuit is configured to eliminate a part of the frequency components of the feed-back signal prior to utilizing the update signal for training the adaptive filter.

16. The device according to claim 15, further comprising a node in the receive path, the node being coupled to an output of the adaptive filter, wherein the training circuit comprises a feed-back loop coupling the node and an input of the adaptive filter, the feed-back loop comprising a filter configured to remove a predetermined frequency band.

17. The device according to claim 16, wherein the device is configured to receive first signals from a far-end side during the training, the received first signals being limited to the predetermined frequency band.

18. The device according to claim 17, wherein the received first signals are handshake signals.

19. A data transmission system comprising:
a plurality of first transceivers at a first side of the data transmission system;
a plurality of second transceivers at a second side of the data transmission system;
a plurality of links coupling the plurality of first transceivers with the plurality of second transceivers;
at least one adaptive filter arranged at the first side of the data transmission system to compensate near-end noise for a first receive path provided in one of the plurality of first transceivers, wherein the system is configured to transmit during an adaptive filter training period first signals from a first transmit path provided in one of the plurality of second transceivers to the first receive path.

20. The data transmission system according to claim 19, wherein the adaptive filter is configured for compensation of NEXT noise, wherein the data transmission system is configured to transmit the first signals on a first link and to transmit during the training second signals from the first side to the second side over a second link, the system being configured to train the adaptive filter based on noise induced by the second signals into the first receive path.

21. The data transmission system according to claim 20, wherein the data transmission is configured to train parallel to the adaptive filter at least a second adaptive filter at the first side of the transmission system, the second adaptive filter being arranged to compensate NEXT noise induced from the first transmit path into a second receive path, wherein the second receive path receives during the parallel training third signals transmitted from the second side of the trans-mission system over a third link to the second receive path, the second adaptive filter being trained based on noise induced by the second signals into the second receive path at the first side of the data transmission system.

22. The data transmission system according to claim 20, the data transmission system further being configured to train parallel to the adaptive filter at least a second adaptive filter, wherein the second adaptive filter is arranged at the first side of the transmission system to compensate NEXT noise induced from a second transmit path into the first receive path, the second transmit path being configured to transmit during the parallel training third signals from the first side over a third link to the second side, the second adaptive filter being trained based on noise induced by the third signals into the first receive path.

23. The data transmission system according to claim 19, wherein the data transmission system is further configured to:
transmit during the training period on each of the plurality of links first signals from the second side to a plurality of receive paths at the first side, and
transmit on each of a plurality of links second signals from the first side to the second side, and
train in parallel a plurality of adaptive filters, the plurality of adaptive filters including the first adaptive filter, each of the plurality of adaptive filters arranged at the first side to compensate near-end noise induced from one of the plurality of transmit paths to one of the plurality of receive paths.

24. The data transmission system according to claim 23, wherein the plurality of adaptive filters includes a first plurality of echo filters and a second plurality of NEXT compensation filters, the method further comprising:
training in parallel the plurality of echo filters and the plurality of NEXT compensation filters.

25. The data transmission system according to claim 19, wherein the first signals are handshake signals.
